(19) United States
(12) Patent Application Publication
(10) Pub. No.: US 2003/0134920 A1
(43) Pub. Date: Jul. 17, 2003

(54) Reinforced polymeric foams

(76) Inventors: William Howard Poisl, Tucson, AZ (US); Brian Joseph Zelinski, Tucson, AZ (US); Donald Robert Uhlmann, Tucson, AZ (US); John Dale Hudson, Amsterdam (NL)

Correspondence Address: Eugene R. Montalvo, Shell Oil Company, Legal - Intellectual Property, P. O. Box 2463, Houston, TX, 77252-2463, US

(21) Appl. No.: 10/310,363

(22) Filed: Dec. 5, 2002

Related U.S. Application Data
(60) Provisional application No. 60/338,554, filed on Dec. 5, 2001.

(51) Int. Cl. C08J 9/16

(52) U.S. Cl. 521/59

(57) ABSTRACT

There is provided a polymeric foam insulation structure comprising a foamed polymer and hollow microspheres; wherein the compressive strength for a given thermal conductivity exceeds values given by the relation σ=2667−2.3031×10⁵(k)+7.1049×10⁶(k)²−4.098×10^{7(k)}³.

### FIELD OF THE INVENTION

This invention relates to insulation structures comprising polymeric foams having novel strength and resistance to compression properties and novel combinations of compressive strength, resistance to compression and thermal conductivity, and further, to pipe structures comprising a length of pipe combined with such insulation structures.

### BACKGROUND OF THE INVENTION

Foams are multi-phase materials in which a solid matrix phase contains a gaseous phase which results in a structure of the form of open and/or closed cells. When used as an insulating coating in pipe structures such as subsea pipelines, the foam structure may see pressures of 5 atmospheres or more, and must be capable of being deployed using methods which can subject the structure to significant strains. The insulating foam structure must, therefore, be flexible, have high strength and resistance to compression (sufficient to withstand forces from deployment and the undersea environment) and low thermal conductivity.

The first criterion, flexibility, can be met by the use of insulating foam structures comprising a variety of polymeric foam systems; but such systems by themselves have inadequate strength and resistance to compression for many undersea applications, particularly at significant depths where pressures on the foam structures can be high.

The second criterion, strength and resistance to compression, may be met by selected polymeric foam insulating structures comprising hollow inorganic microspheres. It is known to incorporate various products as modifiers in foam formulations and in formulations of resins used in reaction injection molding. For example, prior art teaches flexible polyurethane foams containing flyash (see Massey U.S. Pat. No. 3,917,547), syntactic foams comprising hollow glass microspheres in low density polydiene resins (see Lagally U.S. Pat. No. 3,954,686), urethane-modified polyisocyanurate foams containing hollow glass microspheres (see Wells U.S. Pat. No. 3,993,608), rapid-setting polyurethanes with hollow microspheres (see Cravens U.S. Pat. No. 4,038,238 and Howe et al. U.S. Pat. No. 4,044,083), and polyurethane containing glass microspheres (see Harper U.S. Pat. No. 4,082,702). However, means to develop high insulating characteristics and high strengths of foams at pressure are rarely addressed. In fact, the two properties work against each other.

A material commonly used for subsea applications is known as “syntactic foam.” Syntactic foams are actually not foams at all. The structure of a syntactic foam does not have a foamed matrix, but rather uses a dense polymer resin (e.g., polypropylene) as the matrix. This structural feature is true of all syntactic foams, although called “foams,” there is no foam in the structure. Rather, syntactic foams consist of a dense polymer matrix which binds together hollow glass or polymer beads or spheres which provide the insulating gas phase. A significant contribution to the insulating characteristics is provided by air pockets in the hollow particles, which serve a similar purpose as the gas pockets in a foam. In typical syntactic foams, the matrix polymer contains notably less than 10 %v voids or gas phase.

One commercial syntactic foam is a product sold by Thermotite under the trade name Carizite. This product consists of hollow glass microspheres embedded in a dense polymer. Like other syntactic foams, the structure does not have a foamed matrix, but rather uses a dense polymer resin (e.g., polypropylene) as the matrix. The thermal conductivity of syntactic foams such as Carizite (0.098 BTU/hr R ft) is notably higher than that desirable for many undersea insulation applications.

There is therefore a need for a superior insulation material which combines high strength and high resistance to compression with low thermal conductivity and which can be used to provide effective insulation of pipe structures at considerable depths in an undersea environment.

### SUMMARY OF THE INVENTION

This invention provides insulation structures having novel combinations of high strength and resistance to compression combined with low thermal conductivity, heretofore not known in the prior art. In particular, this invention provides insulation polymeric foam insulation structures comprising a foamed polymer and hollow microspheres; wherein the compressive strength for a given thermal conductivity exceeds values given by the relation

σ=2667−2.3031×10⁵(k)+7.1049×10⁶(k)²−4.098×10⁷(k)³.

There is also provided a foam insulation structure comprising a foamed polymer and hollow microspheres; wherein the compressive strength for a given volume fraction of polymer+microspheres exceeds that of the corresponding unfilled foam of the same V_{M}.

In another embodiment, there is provided a polymeric foam insulation structure comprising a foamed polymer and hollow microspheres; wherein the compressive modulus for a given thermal conductivity exceeds values given by the relation:

E=−71539+3.667×10⁶(k)−9.1676×10⁶(k)²−9.7734×10⁶(k)³.

Further, there is provided a polymeric foam insulation structure comprising a foamed polymer and hollow microspheres, wherein the compressive modulus for a given thermal conductivity exceeds values given by the relation:

E=−71539+3.667×10⁶(k)−9.1676×10⁶(k)²−9.7734×10⁶(k)³;

and the compressive strength for a given thermal conductivity exceeds values given by the relation:

σ=2667−2.3031×10⁵(k)+7.1049×10⁶(k)²−4.098×10⁷(k)³.

Another embodiment provides a foam insulation structure comprising a foamed polymer and hollow microspheres; wherein the compressive strength for a given volume fraction of polymer+microspheres exceeds that of the corresponding unfilled foam of the same V_{M} and the thermal conductivity for a given volume fraction of polymer+microspheres is smaller than that of the corresponding unfilled foam of the same V_{M}.

Further, there is provided a foam insulation structure comprising a foamed polymer and hollow microspheres; wherein the compressive modulus for a given volume fraction of polymer+microspheres exceeds that of the corresponding unfilled foam of the same V_{M} and the thermal conductivity for a given volume fraction of polymer+microspheres is smaller than that of the corresponding unfilled foam of the same V_{M}.

There is also provided a foam insulation structure comprising a foamed polymer and hollow microspheres; wherein the compressive strength for a given volume fraction of polymer+microspheres exceeds that of the corresponding foam of the same V_{M}, the compressive modulus for a given volume fraction of polymer+microspheres exceeds that of the corresponding unfilled foam of the same V_{M} and the thermal conductivity for a given volume fraction of polymer+microspheres is smaller than that of the corresponding unfilled foam of the same V_{M}.

The insulations structures may also be included as part of an insulated pipe structure comprising a length of pipe having an outer surface, and a foamed insulation structure surrounding said outer surface.

### BRIEF DESCRIPTION OF THE DRAWINGS

FIG. 1 shows a typical stress-strain curve observed in compression testing for the microsphere-reinforced foam structures of the present invention.

FIG. 2 shows the compressive strength (in psi) vs. Vₘ for unfilled foams and for foam structures containing the indicated V_{SM} of hollow glass microspheres. The solid lines shown in the figure represent least squares power-law fits to the data.

FIG. 3 shows the compressive strength (in psi) vs. Vₘ for unfilled foams and for foam structures containing between about 0.30 and 0.37 V_{SM} of hollow glass microspheres. The solid lines shown in the figure show the power-law fit from FIG. 2.

FIG. 4 shows the compressive modulus (in psi) vs. Vₘ for unfilled foams and for foam structures containing the indicated V_{SM} hollow glass microspheres. The solid lines shown in the figure represent least squares linear fits to the data.

FIG. 5 shows the calculated thermal conductivity of foam structures (in BTU/hr F ft) vs. Vₘ for three different values of V_{SM} for microspheres having a density of 0.6 gm/cc.

FIG. 6 shows the calculated thermal conductivity of foam structures (in BTU/hr F ft) vs. Vₘ for three different values of V_{SM} for microspheres having a density of 0.2 gm/cc.

FIG. 7 shows the compressive strength vs. calculated thermal conductivity of unfilled foams and foam structures containing K20 and S60 hollow glass microspheres, as well as the compressive strength (σ) vs. thermal conductivity (k) relationship:

σ=2667−2.3031×10⁵(k)+7.1049×10⁶(k)²−4.098×10⁷(k)³.

FIG. 8 shows the compressive modulus vs. calculated thermal conductivity of unfilled foams and foam structures containing K20 and S60 microspheres, as well as the compressive modulus (E) vs. thermal conductivity (k) relationship:

E=−71539+3.667×10⁶(k)−9.1676×10⁶(k)²−9.7734×10⁶(k)³.

### DETAILED DESCRIPTION OF THE INVENTION

It has been found that use of appropriate combinations of selected hollow ceramic or glass microspheres together with a foamed polymer results in exceptional combinations of mechanical properties and insulation properties. The polymeric foam structures of the present invention, which are filled with large concentrations of hollow glass or ceramic microspheres, offer particularly desirable combinations of mechanical properties (compressive strength and resistance to compression) together with thermal insulation properties which have heretofore been unobtainable; and it is such novel combinations of high strength, high resistance to compression and low thermal conductivity which render the materials attractive for many demanding applications, most notably the insulation of undersea pipe structures, especially pipe structures used at considerable depths. For these applications, the novel materials of the present invention provide desirably low thermal conductivity coupled with the ability to withstand high mechanical loads and the ability to be deployed using reel methods.

It has been discovered that, when considering the mechanical properties of the filled foam structures, there is a minimum strength of the glass or ceramic microspheres used to reinforce polymeric foams in order to obtain foam structures having desired properties. Also discovered was a condition for obtaining positive reinforcement (increased compressive strength and compressive modulus for a constant volume fraction of matrix, including the microsphere volume) of the foams—viz., that the microspheres must be stronger and stiffer than the volume of the matrix of the foam which they replace when introduced into the foam structure. These discoveries were used to establish the minimum density of microspheres which will provide positive reinforcement. It was found that many commercially-available hollow glass or ceramic microspheres and most hollow polymer microspheres do not fulfill this criterion.

Of particular importance for foam structures used for insulating purposes (as opposed to those used primarily for structural purposes), was the discovery that foam structures can be prepared which possess desirable mechanical properties—for some applications, critical mechanical properties—without undue sacrifice of their insulating properties. This combination of properties renders such foam structures particularly valuable for certain demanding applications, such as the insulation of undersea pipe structures, particularly pipe structures used at considerable depths.

Foam structures of high strength and resistance to compression can be obtained by forming composite foams comprising hollow glass or ceramic microspheres. Such microspheres are not the only materials which can be used to modify foam structures. For example, small solid ceramic particles, of sizes between ten nanometers and tens of microns, or fine ceramic fibers could also be used. Use of such foam modifiers can have a beneficial effect on the mechanical properties of the resulting foams. It is difficult, however, to achieve high loadings (high volume fractions) of such modifiers without causing considerable problems with processing. Further, the inclusion of such foam modifiers in sizable loadings will have a pronounced negative effect on the insulating properties of the foam structures. Since the thermal conductivities of glasses, and particularly of ceramics, are notably higher than those of the polymers used in foam formulations, inclusion of sizable fractions of such modifiers will inevitably lead to substantial increases in the thermal conductivity of the foam structures.

In a similar fashion, the use of hollow polymer microspheres will result in desirable reductions in the thermal conductivity of foams to which they are added; but such reductions in thermal conductivity will generally be obtained at the expense of significant reductions in mechanical strength and stiffness (modulus) compared with the corresponding properties of foams modified with glass or ceramic microspheres. This is because the strengths and moduli of typical hollow polymer microspheres are lower than the strengths and moduli of similar ceramic (including glass) microspheres.

The present invention is directed to overcoming these deficiencies of the prior art. The foam structures of the present invention contain more than about 20 vol % gas phase in the polymer (excluding gas in the microspheres), and typically contain about 40-60 vol % gas phase in the polymer. The foam character of the matrix polymer contributes significantly to the insulating characteristics of the overall composite material.

The volume fraction of the material which constitutes gas-filled pores or cells which form in the foam during the blowing process represents the volume fraction of blown cells, V_{bc}. The volume fraction of the matrix polymer+microsphere volume is designated herein as Vₘ, where Vₘ=1−V_{bc}. If Vₚ is the volume of the foam structure occupied by a polymer, Vₛ is the volume of the foam structure occupied by microspheres, and V is the volume of the overall foam structure,

Vₘ=(Vₚ+Vₛ)/V (1)

For unfilled foams, Vₛ=0, and

Vₘ=Vₚ/V (2)

Another parameter which is useful in characterizing the foam structures of the present invention is V_{SM}, the volume fraction of microspheres in the matrix. That is,

V_{SM}=Vₛ/(Vₛ+Vₚ) (3)

A variety of hollow ceramic (including glass) microspheres may be used in the present invention. For reasons of cost and thermal conductivity, glass microspheres are often preferred; but hollow microspheres of crystalline ceramics may also be employed, particularly where high strength microspheres are desired. As used herein, the term glass is used to denote both completely amorphous materials and amorphous materials containing up to about 90 vol % of a crystalline phase. Crystalline ceramic microspheres are exemplified by microspheres of aluminum oxide, mullite and cordierite, and by compositions based on these compounds. Among glass microspheres which can be utilized in the present invention are those sold by 3M under the designations K46, H50 and S60. The true densities of these three products are 0.46 gm/cm³ (K46), 0.50 gm/cm³ (H50) and 0.60 gm/cm³ (S60). Such products have different crushing strengths, ranging from 6,000 psi for K46 to 10,000 psi for H50 and S60. Also useful are hollow glass microspheres derived from slag, fly ash and similar products.

Other hollow glass microspheres may also be used in certain aspects of the present invention. For example, microspheres with lower densities may be used for foams where very low thermal conductivities are desired, but which foams do not demand high compressive strengths. Additional hollow microspheres which may be employed in certain aspects of this invention include Q-Cel 640D and 650D and SPHERICEL® 110P8 glass microspheres produced by PQ Corporation, and several of the high-strength FILLITE® cenospheres (e.g., SGHA and SGVHA cenospheres) sold by Trelleborg Fillite Ltd.

The hollow glass microspheres may be combined with the foam precursor resin without surface treatment of the microspheres. In many cases, however, it is advantageous to use microspheres whose surfaces have been modified to make them more compatible with the resin of the foam and to promote bonding between the microspheres and the resin. The particular surface treatment should be tailored to the resin, and may include treatments with a number of organosilanes known in the art of coupling agents (e.g., epoxy silanes) as well as specifically-modified resins (e.g., siloxy-functionalized urethanes).

Hollow microspheres with mean particle sizes between 5 microns and 150 microns may be used with the present invention. Preferred microspheres have mean sizes between 10 microns and 80 microns; and most preferred microspheres have mean sizes between 10 microns and 70 microns. It is typically the case that the hollow microspheres are characterized by a range of particle sizes. For example, microspheres with a mean size of 40 microns may comprise particles with sizes between 10 and 70 microns. It is generally preferred to have relatively narrow size distributions of the hollow microspheres, as a range between 20 microns and 60 microns would be preferred over a range between 10 microns and 80 microns. It is specifically preferred to avoid particularly large particles in a distribution (i.e.; to ensure that microspheres larger than a certain particular size, such as those larger than about 70 microns, are effectively excluded from the distribution).

Hollow polymer microspheres may also be combined with hollow glass or ceramic microspheres. The inclusion of the hollow polymer microspheres is useful in lowering the thermal conductivity of the overall foam; but in keeping with the spirit of the present invention, the polymer microspheres, when present, are used at concentrations not to exceed 50 %w, preferably not to exceed 30 %w of the weight of the hollow ceramic (including glass) microspheres. Exemplary hollow polymer microspheres include DUALITE® polymer microspheres sold by Pierce & Stevens Corp. and EXPANCEL® polymer microspheres sold by Expancel Inc.

The composite foams of the present invention may also contain strong hollow glass or ceramic macrospheres as well as hollow polymer beads. As in the case of composite foams made with hollow ceramic (including glass) microspheres, the hollow polymer beads are used principally to increase the volume of the gas phase in the foams, and hence decrease their thermal conductivities. The mean size of the hollow polymer beads, or of the hollow ceramic (including glass) macrospheres, is in the range of 0.2 to 5 mm, preferably 0.3 to 2 mm.

A range of known polymer foam systems may be used. Included in such foam systems known in the art are polystyrene foams, polyurethane foams (i.e. foams derived from isocyanates, including polyurethanes, polyisocyanurates, polyurethane-modified polyisocyanurates), epoxy foams, and polyimide foams. Foams of the invention may also be made with novel hybrid organic-inorganic polyceram foams. Of these, polyurethane foams and epoxy foams are preferred. Such foams offer the potential for achieving relatively high strength foams without the addition of the hollow microspheres, and can provide foams with improved mechanical and insulating properties when filled with appropriate concentrations of appropriate hollow microspheres.

In most insulation applications of foams, it is considered important to ensure that a considerable majority of the cells in the foam be closed, that the open-cell content of the foam be minimized, and even that the cells of the foam be filled with a low-conductivity gas. Indeed, most rigid polyurethane foams consist predominantly of closed cells (closed cell contents of 90-95% are typical). In contrast, with the novel composite foams of the present invention, the thermal conductivity is not greatly adversely affected by the presence of a considerable fraction (such as 25%) of open cells in the foam; and it is not necessary to have pores filled with a low-conductivity gas in order to achieve low thermal conductivity structures.

In the formation of the polyurethane-based foams of the invention, use is made of isocyanates with two or more NCO groups. Aromatic, aliphatic, cycloaliphatic, as well as di- and poly-isocyanates and combinations of these types, may be employed in practicing the invention. The preferred isocyanates are the aromatic isocyanates such as MDI and TDI.

The polyols which are useful in practicing the present invention have molecular weights in the range 500 to 6000, preferably 600 to 2000. These may be used as individual compounds (having a distribution of molecular weights) or as mixtures of these compounds. Also useful in practicing the invention are diamines (e.g., toluylene diamine and diaminodiphenylmethane) and polyamines (e.g., polyether amines).

Polymeric foams may be prepared using a wide variety of chemical or physical blowing agents. In practicing the present invention, the preferred blowing agent is carbon dioxide, which typically is produced by reaction of water with the isocyanate groups. Increasing concentrations of water produce foams of lower density. Also useful as blowing agents, but less preferred, are low-boiling liquids such as the chlorofluorocarbons, hydrochlorofluorocarbons and pentane.

Surfactants are useful additions to help prevent foam collapse and avoid undesirably coarse cell structures. Exemplary surfactants are silicones and silicone copolymers, which are typically incorporated in concentrations of 0.5-1 %w. Use of higher viscosity silicone copolymers generally produces foams with less coarse cell structures. Also useful are catalysts such as amines or tin compounds.

In addition to the above-mentioned constituents, the foams of the present invention may also contain various additives to facilitate the processing or contribute to desired properties of the final composite foams. Such additives include stabilizers to protect the foams against thermal, hydrolytic, oxidative or UV degradation. A variety of such compounds are known in the art. When desired, a variety of known colorants may also be used in the present formulations. When urethane color pastes are employed for this purpose, the hydroxyl content of the paste should be compensated for by increasing the amount of isocyanate in the foam formulation.

When desired, nucleating agents such as talc, titania or carbon black may be added to decrease the average cell size of the foam and thereby increase the compressive strength. These can also provide some protection against UV degradation, but can present processing problems especially when using larger particle size additions (beyond the pigmentary range).

When using polyurethane foams, the hollow ceramic (including glass) microspheres may be added to the first part only (the isocyanate part), to the second part only (the polyol part), or to both the first part and the second part. The catalyst, blowing agent, stabilizers, etc. are generally added to the second part.

Since the properties of foamed polymers are known to depend on the density of the foam, this is an important parameter to monitor and control. Foams of a given density may be produced using both free rise and constrained rise (molding) methods of foam formation. For the composite foams of the present invention, it typically has little effect on the properties of the foams, for a given foam density, whether the foams are made using free rise or constrained rise. For polyurethane foams made under free rise conditions, the density of the filled foam may be modified by drying the glass microspheres prior to incorporating them in the polyurethane precursors.

### EXAMPLES

In the examples, the samples were prepared by first mixing appropriate weighed quantities of hollow microspheres and either the isocyanate or polyol plus additives in a plastic sample cup. The mixing was carried out by hand for approximately one minute. The other part (either polyol plus additives or isocyanate) of the formulation was added to the first microsphere-liquid mixture and mixed with a paint stirrer attached to a high speed mixer (approximately 2000 rpm) for approximately 20 sec. During mixing, the sample cup was rotated and tilted to ensure that the material along the bottom and sides of the sample cup was mixed.

If a free-rise foam were desired, the sample cup was then left undisturbed while foaming took place. When it was desired to form a molded sample, a lid was screwed onto the sample cup once the foam had risen to near the top of the cup. This prevented an undue amount of air to be trapped in the sample cup during molding, as well as the foam popping off the lid, and allowed repeatable molded densities to be obtained.

It was noted that the free-rise density could be affected by the surface condition of the hollow microspheres. This was explored as follows: Samples with the desired weight of microspheres were prepared in the standard manner. One set of samples used the microspheres as-received from the manufacturer; while the other used microspheres which had been dried just prior to preparing the foam samples. Drying was accomplished by heating a quantity of hollow microspheres in a TEFLON® dish in a commercial microwave oven at the highest setting for 6 min. total. At 2-min. intervals, the heating was stopped and the microspheres were gently stirred. It was found that drying the microspheres increased the free-rise density by 5-10%.

Specimens for measuring the density and mechanical properties were cut from the foamed samples using a band saw with a tungsten carbide-tipped blade. The cut specimens were 0.5×0.5×1 inch. Each specimen was weighed; and the dimensions were measured in order to calculate the density. The mechanical testing of the specimens was carried out using an INSTRON® machine at a crosshead speed of 0.5 inch/min. The testing was carried out to an engineering strain of approximately 20%. All specimens were tested in the rise direction. The data on load and extension were recorded electronically and converted to stress and strain using the dimensions of the given specimen. The procedures of ASTM D-1621 were followed to calculate the peak stress, and strain at peak stress from the stress-strain curve. The compressive strength was identified as the peak stress. For specimens which did not exhibit a peak in stress, the stress at 5.5% strain (after toe compensation) was determined and used as the compressive strength. The modulus was determined as the maximum slope calculated from a slope analysis of the stress-strain curve over a strain range of 1%. Outliers were eliminated at the 95% confidence level using the Student T-test. The coefficient of variation for compressive strength was 2.0%; and for modulus, it was 3.4%. Values of density, modulus and compressive strength for a given foam are the averages of 3 or 4 specimens.

The microstructural characteristics of the foam structures were determined by grinding and polishing surfaces of the foams (both internal surfaces prepared by sectioning and external surfaces) up to 1200 grit to obtain flat, smooth surfaces. These surfaces were examined uncoated using a nature scanning electron microscope at 25 kV using backscattered electrons. The blown cells could be observed directly, as could microspheres just below the surface as well as those which had been sectioned.

In general it was observed that the size of the blown cells decreased with the addition of the hollow microspheres, for a given final density. The filled foam structures usually included more relatively large blown cells than the unfilled foams. These larger cells are likely due to air entrapped in the material during mixing. With increased viscosity of the fluid due to the addition of the microspheres, these mixing bubbles did not have time to rise to the surface of the fluid before the foam began to rise/set. As an comparative example, it was found that an uinfilled 28 PCF foam sample had cells approximately 0.4 mm in diameter, while a foam structure filled with V_{SM}=0.30 of S60 hollow glass microspheres having a density of 27 PCF had most cells with a diameter of about 0.15 mm or smaller, and only a few cells as large as 0.3 mm.

In Table I are presented examples of unfilled and microsphere-reinforced foams. Table I gives the weights of isocyanate, polyol and spheres used to make each examples, and the resultant properties of each foam. All foams were produced with BUC-505 Series resin with nominal free-rise densities of 20 or 30 PCF from Burtin Corporation (Santa Ana, Calif.). Samples 1-9, 15-26, and 39-63 were produced using 20 PCF free-rise foam, the rest from 30 PCF free-rise foam. Glass microspheres used were either K20 or S60 from 3M (St. Paul, Minn.). All samples were molded except for examples 1, 10, 20, 26, 32 and 38, which were free-rise samples. All samples had spheres added to the isocyanate side only, except for examples 49 to 53, for which the spheres were added to the polyol side, and samples 54 to 58, for which spheres were added equally to both the isocyanate and the polyol.

TABLE 1
Examples of filled and unfilled foams.

| | | Isocyanate | Polyol | Sphere | | | Average | Average |
|---|---|---|---|---|---|---|---|---|
| | Sphere | weight | weight | weight | Density | | Strength | Modulus |
| Ex. | Type | (g) | (g) | (g) | (PCF) | V_{M} | (psi) | (psi) |
| 1 | unfilled | 20.80 | 19.20 | 0.00 | 18.52 | 0.270 | 788 | 23,766 |
| 2 | unfilled | 52.00 | 48.00 | 0.00 | 21.08 | 0.307 | 971 | 30,865 |
| 3 | unfilled | 52.00 | 48.00 | 0.00 | 24.76 | 0.361 | 1,344 | 38,621 |
| 4 | unfilled | 10.40 | 9.60 | 0.00 | 21.68 | 0.316 | 1,114 | 37,661 |
| 5 | unfilled | 15.60 | 14.40 | 0.00 | 19.81 | 0.288 | 897 | 27,356 |
| 6 | unfilled | 20.80 | 19.20 | 0.00 | 20.04 | 0.292 | 964 | 28,248 |
| 7 | unfilled | 26.00 | 24.00 | 0.00 | 22.90 | 0.333 | 1,235 | 35,660 |
| 8 | unfilled | 31.20 | 28.80 | 0.00 | 25.83 | 0.376 | 1,562 | 44,862 |
| 9 | unfilled | 41.60 | 38.40 | 0.00 | 29.41 | 0.428 | 1,932 | 53,050 |
| 10 | unfilled | 26.00 | 24.00 | 0.00 | 31.34 | 0.456 | 2,193 | 56,626 |
| 11 | unfilled | 39.00 | 36.00 | 0.00 | 26.67 | 0.388 | 1,654 | 39,543 |
| 12 | unfilled | 44.20 | 40.80 | 0.00 | 31.54 | 0.459 | 2,216 | 52,803 |
| 13 | unfilled | 49.40 | 45.60 | 0.00 | 34.31 | 0.500 | 2,706 | 62,851 |
| 14 | unfilled | 54.60 | 50.40 | 0.00 | 37.85 | 0.551 | 3,296 | 73,668 |
| 15 | K20 | 18.20 | 16.80 | 2.63 | 16.76 | 0.321 | 826 | 26,678 |
| 16 | K20 | 20.80 | 19.20 | 3.01 | 17.56 | 0.336 | 865 | 27,619 |
| 17 | K20 | 23.40 | 21.60 | 3.39 | 19.92 | 0.382 | 1,135 | 34,752 |
| 18 | K20 | 26.00 | 24.00 | 3.76 | 21.68 | 0.415 | 1,362 | 39,443 |
| 19 | K20 | 28.60 | 26.40 | 4.14 | 23.54 | 0.451 | 1,622 | 44,237 |
| 20 | K20 | 13.00 | 12.00 | 1.88 | 16.61 | 0.318 | 824 | 25,833 |
| 21 | K20 | 18.20 | 16.80 | 3.89 | 16.50 | 0.348 | 779 | 24,281 |
| 22 | K20 | 20.80 | 19.20 | 4.44 | 17.71 | 0.374 | 907 | 29,057 |
| 23 | K20 | 23.40 | 21.60 | 5.00 | 19.96 | 0.421 | 1,158 | 34,994 |
| 24 | K20 | 26.00 | 24.00 | 5.56 | 22.29 | 0.471 | 1,499 | 44,479 |
| 25 | K20 | 28.60 | 26.40 | 6.11 | 23.35 | 0.493 | 1,675 | 47,962 |
| 26 | K20 | 13.00 | 12.00 | 2.78 | 16.04 | 0.339 | 764 | 23,681 |
| 27 | K20 | 23.40 | 21.60 | 3.39 | 23.35 | 0.447 | 1,491 | 43,640 |
| 28 | K20 | 26.00 | 24.00 | 3.76 | 24.15 | 0.462 | 1,598 | 45,929 |
| 29 | K20 | 28.60 | 26.40 | 4.14 | 25.18 | 0.482 | 1,679 | 47,055 |
| 30 | K20 | 31.20 | 28.80 | 4.52 | 27.31 | 0.523 | 1,993 | 53,645 |
| 31 | K20 | 33.80 | 31.20 | 4.89 | 29.37 | 0.562 | 2,326 | 59,975 |
| 32 | K20 | 18.20 | 16.80 | 2.63 | 23.24 | 0.445 | 1,491 | 43,810 |
| 33 | K20 | 23.40 | 21.60 | 5.00 | 22.40 | 0.473 | 1,403 | 42,185 |
| 34 | K20 | 26.00 | 24.00 | 5.56 | 23.39 | 0.494 | 1,544 | 46,303 |
| 35 | K20 | 28.60 | 26.40 | 6.11 | 25.41 | 0.537 | 1,835 | 53,805 |
| 36 | K20 | 31.20 | 28.80 | 6.67 | 27.31 | 0.577 | 2,256 | 62,115 |
| 37 | K20 | 33.80 | 31.20 | 7.22 | 29.18 | 0.616 | 2,588 | 68,219 |
| 38 | K20 | 18.20 | 16.80 | 3.89 | 22.02 | 0.465 | 1,379 | 45,295 |
| 39 | S60 | 26.00 | 24.00 | 12.00 | 27.28 | 0.461 | 2,825 | 70,878 |
| 40 | S60 | 28.00 | 25.85 | 12.92 | 23.43 | 0.396 | 1,985 | 57,218 |
| 41 | S60 | 30.00 | 27.69 | 13.85 | 25.64 | 0.434 | 2,399 | 62,934 |
| 42 | S60 | 32.00 | 29.54 | 14.77 | 29.21 | 0.494 | 3,222 | 78,643 |
| 43 | S60 | 34.00 | 31.38 | 15.69 | 28.84 | 0.488 | 3,120 | 76,138 |
| 44 | S60 | 16.64 | 15.36 | 7.51 | 19.81 | 0.334 | 1,458 | 44,819 |
| 45 | S60 | 18.72 | 17.28 | 8.44 | 22.60 | 0.381 | 2,009 | 57,069 |
| 46 | S60 | 20.80 | 19.20 | 9.38 | 22.78 | 0.384 | 2,079 | 54,139 |
| 47 | S60 | 22.88 | 21.12 | 10.32 | 19.05 | 0.321 | 1,373 | 41,973 |
| 48 | S60 | 24.96 | 23.04 | 11.26 | 20.34 | 0.343 | 1,647 | 49,156 |
| 49 | S60 | 16.64 | 15.36 | 7.51 | 18.51 | 0.312 | 1,318 | 40,730 |
| 50 | S60 | 18.72 | 17.28 | 8.44 | 18.21 | 0.307 | 1,160 | 38,341 |
| 51 | S60 | 20.80 | 19.20 | 9.38 | 20.23 | 0.341 | 1,485 | 44,371 |
| 52 | S60 | 22.88 | 21.12 | 10.32 | 23.92 | 0.403 | 2,183 | 60,238 |
| 53 | S60 | 24.96 | 23.04 | 11.26 | 21.68 | 0.366 | 1,751 | 50,407 |
| 54 | S60 | 16.64 | 15.36 | 7.51 | 17.80 | 0.300 | 1,189 | 38,308 |
| 55 | S60 | 18.72 | 17.28 | 8.44 | 17.50 | 0.295 | 1,150 | 37,531 |
| 56 | S60 | 20.80 | 19.20 | 9.38 | 22.60 | 0.381 | 2,004 | 56,542 |
| 57 | S60 | 22.88 | 21.12 | 10.32 | 23.10 | 0.390 | 2,082 | 56,467 |
| 58 | S60 | 24.96 | 23.04 | 11.26 | 20.20 | 0.341 | 1,566 | 46,869 |
| 59 | S60 | 16.64 | 15.36 | 10.11 | 19.10 | 0.334 | 1,516 | 47,107 |
| 60 | S60 | 18.72 | 17.28 | 11.37 | 18.20 | 0.318 | 1,341 | 41,572 |
| 61 | S60 | 20.80 | 19.20 | 12.63 | 19.00 | 0.332 | 1,417 | 44,558 |
| 62 | S60 | 22.88 | 21.12 | 13.89 | 20.50 | 0.358 | 1,705 | 51,934 |
| 63 | S60 | 24.96 | 23.04 | 15.16 | 23.00 | 0.402 | 2,244 | 64,704 |
| 64 | S60 | 26.00 | 24.00 | 12.00 | 28.72 | 0.486 | 2,919 | 74,816 |
| 65 | S60 | 28.00 | 25.85 | 12.92 | 28.15 | 0.476 | 2,822 | 72,887 |
| 66 | S60 | 30.00 | 27.69 | 13.85 | 28.29 | 0.478 | 2,845 | 73,819 |
| 67 | S60 | 32.00 | 29.54 | 14.77 | 33.87 | 0.573 | 4,100 | 95,820 |
| 68 | S60 | 34.00 | 31.38 | 15.69 | 31.92 | 0.540 | 3,708 | 88,311 |
| 69 | S60 | 20.80 | 19.20 | 12.63 | 24.80 | 0.433 | 2,627 | 72,416 |
| 70 | S60 | 22.88 | 21.12 | 13.89 | 25.60 | 0.447 | 2,806 | 74,390 |
| 71 | S60 | 24.96 | 23.04 | 15.16 | 27.40 | 0.479 | 3,209 | 82,834 |
| 72 | S60 | 27.04 | 24.96 | 16.42 | 29.40 | 0.514 | 3,810 | 92,795 |
| 73 | S60 | 29.12 | 26.88 | 17.68 | 29.50 | 0.515 | 3,833 | 92,430 |
| 74 | S60 | 31.20 | 28.80 | 18.95 | 30.00 | 0.524 | 3,942 | 95,040 |

A typical stress-strain curve for the microsphere-reinforced foam structures of the present invention is shown in FIG. 1. As shown there, the stress increases with increasing strain up to about 5% strain. This is followed by a modest decrease in stress, which remains relatively constant to large strains. An inflection point in the stress-strain curve is seen at about 1.7% strain. It will be seen below that by following the teachings of the present invention, it is possible to optimize the modulus for a given thermal conductivity, or the thermal conductivity for a given modulus.

It is often observed that the strength of foams varies with the density according to a power law relation. Such relations were found, however, not to be of significant use in describing three-phase foam structures such as those of the present invention. Rather, systematic variations in the behavior of such foams were revealed by considering the variation of strength (and modulus) with Vₘ. It was found that the strength and modulus vary systematically with Vₘ, with the modulus varying linearly with Vₘ and the strength exhibiting a power-law dependence on Vₘ.

For the foams of the present invention, Vₘ ranges from about 0.30 to about 0.65, preferably from about 0.45 to about 0.60, and V_{SM} varies from about 0.15 to about 0.50, preferably from about 0.25 to about 0.40, and the true density of the hollow glass microspheres ranges from about 0.3 to about 0.8 gm/cc, preferably from about 0.4 to 0.6 gm/cc.

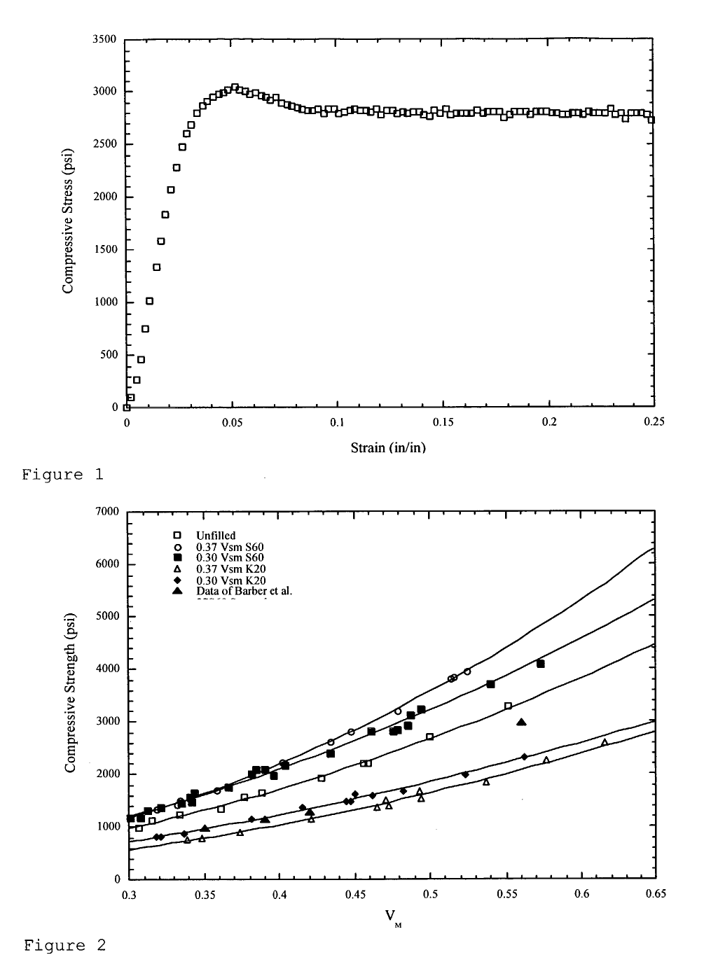

FIG. 2 shows the variation of compressive strength with Vₘ for unfilled polyurethane foams and for polyurethane based foam structures filled with about 0.30 and 0.37 V_{SM} of hollow glass microspheres of various types. Also shown for comparison are data on the prior art foams of Barber et al. [J. Cell. Plast. 13, 1977, 383], for which the parameters used to define the present invention, Vₘ and V_{SM}, were estimated by the present authors. The foams of Barber et al. [J. Cell. Plast. 13, 1977, 383] plotted in FIG. 2 had a V_{SM} of about 0.33.

It is seen from FIG. 2 that for a given Vₘ, foam structures made with K20 microspheres are notably weaker than unfilled foams, with the weakening effect being larger for foams containing a larger content of microspheres. In contrast, the foam structures containing S60 microspheres are notably stronger than the unfilled foams; and, at least for foam structures with sizable volume fraction matrices, the strength increases with increasing microsphere content. Thus different behavior is observed as a function of the microsphere content depending on whether the formulation of the foam structure employs microspheres with strengths which are higher than or smaller than that of the unfilled foam.

It is notable that the prior art samples of Barber et al. [J. Cell. Plast. 13, 1977, 383] are significantly weaker than unfilled foams having the same Vₘ, and are notably weaker than the present foam structures made with S60 microspheres with comparable V_{SM}'S.

Investigations to understand this behavior of prior art filled foams, and more generally the results depicted in FIG. 2, led to a significant finding of the present invention—viz., that for a positive reinforcing effect, the microspheres should have a strength which is higher than that of the equivalent polymer which they replace. Strengths of microspheres above this minimum value will increase the strength of the matrix and thereby produce stronger foams for any given Vₘ.

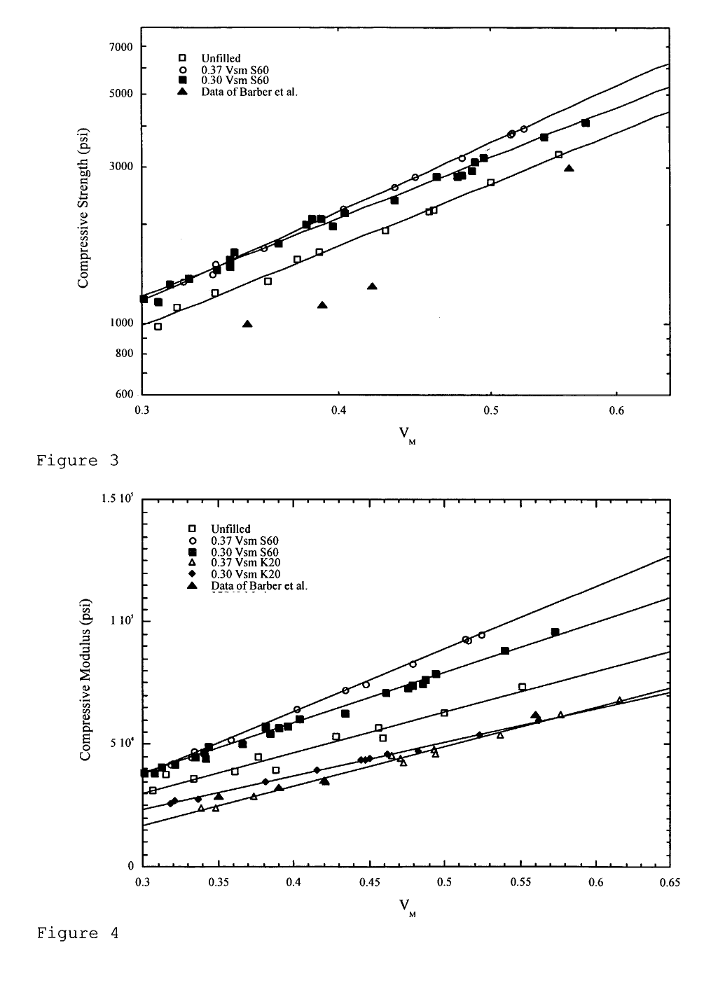

FIG. 3 shows a log-log plot of the compressive strength as a function of Vₘ, for unfilled foams and for foam structures of the present work containing S60 microspheres at V_{SM}'s of about 0.30 and 0.37. Also shown for comparison are data on the prior art foams of Barber et al. [J. Cell. Plast. 13, 1977, 383] at the similar but somewhat smaller Vₘ of about 0.33. It is seen that, in contrast to microsphere-filled foams of the prior art, the present microsphere-filled foam structures exhibit notably higher compressive strengths than the unfilled foams. Note that approximately linear relations are observed between log (strength) vs. log (Vₘ).

Such relations can be constructed for the strength as a function of Vₘ for different types of microspheres. With such relations, it is possible to calculate the strength for any value of Vₘ for a given type of microsphere. It is also possible to evaluate the strength as a function of microsphere density for foam structures of a given Vₘ. When this is done, it is found that the strength increases significantly with increasing microsphere density for a given Vₘ. It is also found that, at least for foam structures containing microspheres at a V_{SM} greater than about 0.30, microspheres with densities greater than about 0.47 gm/cm³ will produce foam structures which are stronger for a given Vₘ than unfilled foams, while microspheres with smaller densities will produce weaker foam structures.

FIG. 4 shows the variation of compressive modulus with volume fraction matrix, Vₘ, for unfilled polyurethane foams and for polyurethane based foam structures filled with V_{SM}=0.30 and 0.37 of hollow glass microspheres of various types in the foam structure. Also shown for comparison are data on the prior art foams of Barber et al. [J. Cell. Plast. 13, 1977, 383], which had a V_{SM} of hollow glass microspheres of about 0.33.

It is seen from FIG. 4 that for a given Vₘ, foam structures made with K20 microspheres have notably lower compressive moduli than unfilled foams, with the stiffness-lowering effect being larger for foams containing a larger content of microspheres. In contrast, the foam structures containing S60 microspheres have notably high compressive moduli than the unfilled foams; and, at least for foam structures with sizable volume fraction matrices, the modulus increases with increasing microsphere content. Thus different behavior is observed as a function of the microsphere content depending on whether the formulation of the foam structure employs microspheres with moduli which are higher than or smaller than that of the unfilled foam.

It is notable that the prior art samples of Barber et al. [J. Cell. Plast. 13, 1977, 383] have significantly lower moduli than unfilled foams having the same Vₘ, and have notably lower moduli than the present foam structures made with S60 microspheres with comparable V_{SM}'S of microspheres in the foam structures.

It is also notable that the least squares best fits to the modulus vs. V_{M} data for the foam structures of the present work are straight lines.

While these mechanical aspects of the present invention are of considerable interest and technological importance in their own right, the key aspects of the present invention are the combination of high strength and high resistance to compression with low thermal conductivity, particularly, the combinations of these properties which enable the effective insulation of pipe structures at considerable depths under water. In evaluating the thermal conductivity, it was found useful to calculate the thermal conductivity of the foam structures with Maxwell's equation for mixing of the blown cells with the matrix. The blown cells are assumed to contain nitrogen with a thermal conductivity of 0.014 BTU/hr F ft. The thermal conductivity of the matrix or cell wall material is calculated using an in-line cube model. In this model, the microspheres are assumed to be cubes of equivalent density embedded in polyurethane to form a simple cubic array. The cube walls are assumed to be made of glass with a density of 2.24 gm/cc and the thermal conductivity of 0.726 BTU/hr F ft. For the calculation, the gas inside the cube is assumed to be nitrogen, and polyurethane is assigned a density of 1.1 gm/cc and thermal conductivity of 0.102 BTU/hr F ft. Variations in the amount and relative density of microspheres in the matrix are accommodated by the model through adjustment in the relative amounts of polyurethane, glass and nitrogen.

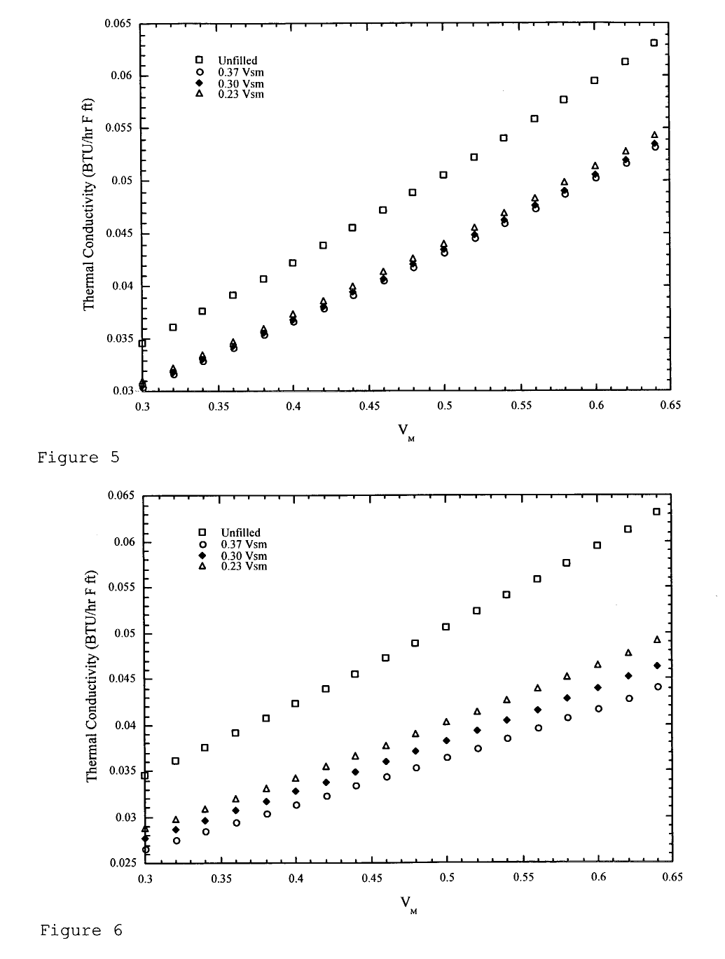

FIGS. 5 and 6 show the thermal conductivities of microsphere-filled foam structures evaluated as a function of the Vₘ of the microspheres, for microspheres having densities of 0.2 and 0.6 gm/cm³, respectively. The S60 microspheres have a density of 0.6 gm/cm³.

As a check on the accuracy of the values of thermal conductivity calculated in this way, using the curves in FIG. 6, the thermal conductivity was predicted for a microsphere-filled foam structure containing a V_{SM} of S60 microspheres of 0.30 (weight fraction of microspheres=0.19) and Vₘ of 0.46. The predicted thermal conductivity was 0.041 BTU/hr F ft. When the thermal conductivity of the sample was measured, it was found to be 0.043 BTU/ hr F ft, in good agreement with the predicted value. Thermal conductivity was measured according to ASTM C-518 at a temperature of 25° C. A 4 inch by 4 inch by 1 inch specimen was used, with the exposed edges covered by a low thermal conductivity material to prevent heat loss from the sample during testing.

By linking the strength and thermal conductivity values for foam structures through the value of Vₘ, relationships were constructed between the thermal conductivity and the compressive strength of foam structures for microspheres having various densities. Such relationships are shown in FIG. 7. This figure demonstrates an unexpected aspect of the present invention, viz., that use of microspheres of high density leads to both higher strength for a given thermal conductivity and lower thermal conductivity for a given strength.

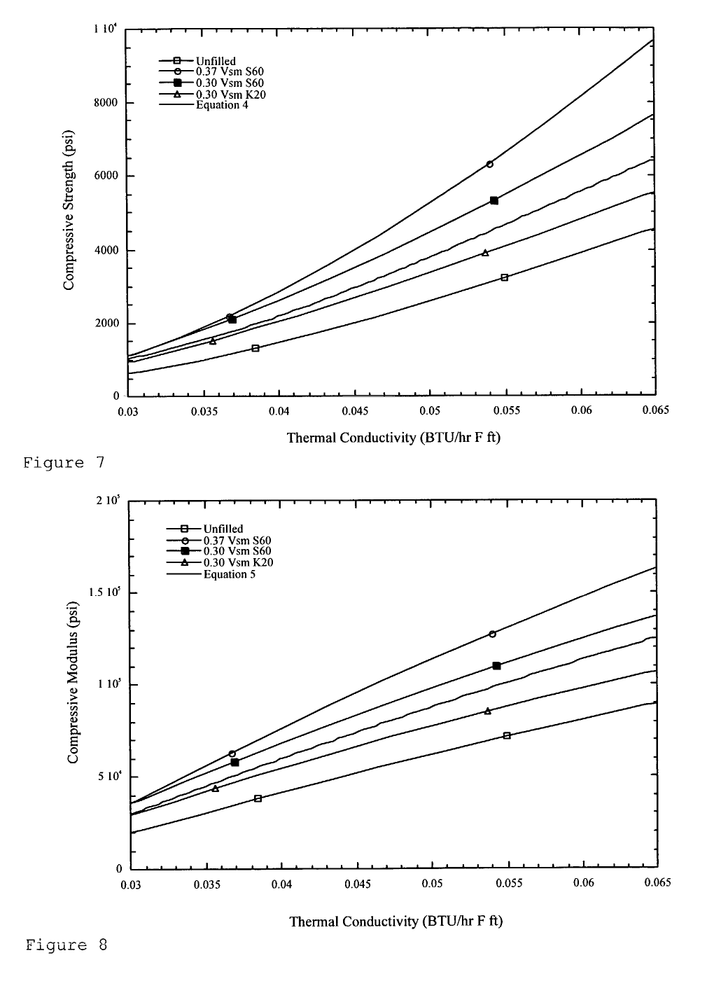

Similarly, by linking the modulus and thermal conductivity values for foam structures through the value of Vₘ, relationships were constructed between the thermal conductivity and the compressive modulus of foam structures for microspheres having various densities. Such relationships are shown in FIG. 8 for unfilled foams and foams containing K20 and S60 microspheres. This figure demonstrates an unexpected aspect of the present invention, viz., that use of microspheres of high density leads to both higher modulus for a given thermal conductivity and lower thermal conductivity for a given modulus.

Further, by combining the results shown in FIGS. 7 and 8, it is seen that it is possible to obtain both higher strength and modulus for a given thermal conductivity, and lower thermal conductivity for a given strength and modulus.

These characteristics have important implications for novel foam insulation structures for deep undersea applications. Absent this discovery, one would be directed to using microspheres of low density when low thermal conductivities are desired.

Of particular interest for deep undersea insulating applications are foam structures whose strengths for a given thermal conductivity exceed the relationship:

σ=2667−2.3031×10⁵(k)+7.1049×10⁶(k)²−4.098×10⁷(k)³ (4)

and whose compressive modulus for a given thermal conductivity exceed the relationship:

E=−71539+3.667×10⁶(k)−9.1676×10⁶(k)²−9.7734×10⁶(k)³ (5)

Of very particular interest are foam structures whose strength and modulus for a given thermal conductivity exceed values given by the relations of Eqns. (4) and (5), and whose Vₘ is between about 0.3 and about 0.65, and whose V_{SM} exceeds about 0.15, and foam structures whose strength and modulus for a given thermal conductivity exceed values given by the relations of Eqns. (4) and (5), whose Vₘ is between about 0.3 and about 0.65, and whose V_{SM} exceeds about 0.15, and which are fabricated using hollow glass microspheres whose true density exceeds about 0.3 gm/cc.

The foams just described are useful for piping snsultation, particularly subsea piping. A typical insulated pipe structure comprises a length of pipe having an outer surface, and a foamed insulation structure such as just described surrounding the outer surface of the pipe. Of particular interest are pipe structures comprising a length of pipe and insulation structures with higher compressive strength and modulus and lower thermal conductivity than unfilled foams of the same Vₘ. Also of considerable interest are pipe structures comprising a length of pipe and insulation structures whose strength and modulus for a given thermal conductivity exceed values given by the relations of Eqns. (4) and (5), and whose Vₘ is between about 0.3 and about 0.65, and whose V_{SM} exceeds about 0.15, as well as pipe structures comprising a length of pipe and insulation structures whose strength and modulus for a given thermal conductivity exceed values given by the relations of Eqns. (4) and (5), whose Vₘ is between about 0.3 and about 0.65, and whose V_{SM} exceeds about 0.15, and which are fabricated using hollow glass microspheres whose true density exceeds about 0.3 gm/cc.

We claim:

1. A polymeric foam insulation structure comprising a foamed polymer and hollow microspheres; wherein the compressive strength for a given thermal conductivity exceeds values given by the relation
Σ=2667−2.3031×10⁵(k)+7.1049×10⁶(k)²−4.098×10⁷(k)³.

2. A foam insulation structure comprising a foamed polymer and hollow microspheres; wherein the compressive strength for a given volume fraction of polymer+microspheres exceeds that of the corresponding unfilled foam of the same Vₘ.

3. A polymeric foam insulation structure comprising a foamed polymer and hollow microspheres; wherein the compressive modulus for a given thermal conductivity exceeds values given by the relation:
E=−71539+3.667×10⁶(k)−9.1676×10⁶(k)²−9.7734×10⁶(k)³.

4. A polymeric foam insulation structure comprising a foamed polymer and hollow microspheres, wherein the compressive modulus for a given thermal conductivity exceeds values given by the relation:
E=−71539+3.667×10⁶(k)−9.1676×10⁶(k)²−9.7734×10⁶(k)³;
and the compressive strength for a given thermal conductivity exceeds values given by the relation:
σ=2667−2.3031×10⁵(k)+7.1049×10⁶(k)²−4.098×10⁷(k)³.

5. A foam insulation structure comprising a foamed polymer and hollow microspheres; wherein the compressive strength for a given volume fraction of polymer+microspheres exceeds that of the corresponding unfilled foam of the same V_{M} and the thermal conductivity for a given volume fraction of polymer+microspheres is smaller than that of the corresponding unfilled foam of the same V_{M}.

6. The foam insulation structure of claim 5, wherein said polymer is selected from polyurethane, polyisocyanurate, epoxy, polyamide, hybrid organic-inorganic polyceram, and combinations thereof.

7. A foam insulation structure comprising a foamed polymer and hollow microspheres; wherein the compressive strength for a given volume fraction of polymer+microspheres exceeds that of the corresponding foam of the same V_{M}, the compressive modulus for a given volume fraction of polymer+microspheres exceeds that of the corresponding unfilled foam of the same V_{M} and the thermal conductivity for a given volume fraction of polymer+microspheres is smaller than that of the corresponding unfilled foam of the same V_{M}.

8. An insulated pipe structure comprising a length of pipe having an outer surface, and a foamed insulation structure surrounding said outer surface; said foam insulation structure comprising a foamed polymer and hollow microspheres, wherein the compressive strength for a given thermal conductivity of the foamed insulation structure exceeds values given by the relation:
σ=2667−2.3031×10⁵(k)+7.1049×10⁶(k)²−4.098×10⁷(k)³.

9. An insulated pipe structure comprising a length of pipe having an outer surface and a foamed insulation structure surrounding said outer surface; said foamed insulation structure comprising a foamed polymer and hollow microspheres; wherein the compressive modulus for a given thermal conductivity of the foamed insulation structure exceeds values given by the relation:
E=−71539+3.667×10⁶(k)−9.1676×10⁶(k)²−9.7734×10⁶(k)³.

10. The insulated pipe structure of claim 9, wherein said polymer is selected from polyurethane, polyisocyanurate, epoxy, polyimide, hybrid organic-inorganic polyceram, and combinations thereof.

11. An insulated pipe structure comprising a length of pipe having an outer surface and a foamed insulation structure surrounding said outer surface; said foamed insulation structure comprising a foamed polymer and hollow microspheres; wherein the compressive modulus for a given thermal conductivity of the foamed insulation structure exceeds values given by the relation:
E=−71539+3.667×10⁶(k)−9.1676×10⁶(k)²−9.7734×10⁶(k)³;
and the compressive strength for a given thermal conductivity of the foamed insulation structure exceeds values given by the relation:
σ=2667−2.3031×10⁵(k)+7.1049×10⁶(k)²−4.098×10⁷(k)³.

12. An insulated pipe structure comprising a length of pipe having an outer surface, and a foamed insulation structure surrounding said outer surface; said foamed insulation structure comprising a foamed polymer and hollow microspheres; wherein the compressive strength for a given volume fraction of polymer+microspheres exceeds that of the corresponding unfilled foam of the same V_{M}, the compressive modulus for a given volume fraction of polymer+microspheres exceeds that of the corresponding unfilled foam of the same V_{M} and the thermal conductivity for a given volume fraction of polymer+microspheres is smaller than that of the corresponding unfilled foam of the same V_{M}.
